(19) United States
(12) Patent Application Publication
(10) Pub. No.: US 2020/0011677 A1
(43) Pub. Date: Jan. 9, 2020

(54) Venue Routing Based on Map Feature Relationships

(71) Applicant: Apple Inc., Cupertino, CA (US)

(72) Inventors: Michael A. Hoather, Austin, TX (US); Ian A. Mondragon, San Jose, CA (US); Tomas Lazaro, San Francisco, CA (US); Stephane Godbillion, San Francisco, CA (US); Antti P. Saarinen, Mountain View, CA (US); Nyla N. Khan, Santa Clara, CA (US)

(73) Assignee: Apple Inc., Cupertino, CA (US)

(21) Appl. No.: 16/506,625

(22) Filed: Jul. 9, 2019

Related U.S. Application Data
(60) Provisional application No. 62/695,303, filed on Jul. 9, 2018.

(51) Int. Cl. G01C 21/34; G01C 21/20

(52) U.S. Cl. CPC G01C 21/3407; G01C 21/206

(57) ABSTRACT

In some implementations, a computing device can generate navigation instructions based on map data that defines the relationships between map features within a venue. For example, a relationship can define constraints that may affect the route generated between map features. The constraints can include directional constraints, time-based constraints, and/or security-based constraints on the user's ability to move between the related map features for which a relationship is defined. A relationship can define one or more intermediary map features through which a user will have to navigate in order to move between map features. The intermediary map feature(s) may have characteristics or constraints that may determine whether a user can be routed through the associated map features. The route generated by the computing device can be based on the relationship definitions generated for map features between a starting location and an ending location associated with the venue.

### TECHNICAL FIELD

The disclosure generally relates to generating and using venue map data.

### BACKGROUND

Navigation applications are becoming more sophisticated. Recently, navigation applications are providing indoor and/or venue mapping and navigation capabilities. However, when the navigation instructions generated and/or presented by these navigation applications do not account how the relationships between map features may affect the user's ability to follow the presented navigation instructions, the user may become frustrated or lost when the user is unable to follow the venue navigation instructions presented by the navigation application.

### SUMMARY

In some implementations, a computing device can generate navigation instructions based on map data that defines the relationships between map features within a venue. For example, a relationship can define constraints that may affect the route generated between map features. The constraints can include directional constraints, time-based constraints, and/or security-based constraints on the user's ability to move between the related map features for which a relationship is defined. A relationship can define one or more intermediary map features through which a user will have to navigate in order to move between map features. The intermediary map feature(s) may have characteristics or constraints that may determine whether a user can be routed through the associated map features. The route generated by the computing device can be based on the relationship definitions generated for map features between a starting location and an ending location associated with the venue.

Particular implementations provide at least the following advantages. By defining relationships, and constraints on relationships, venue map data can more precisely model the real-world environment through which a user must navigate. By encoding map element (e.g., map feature) relationships, and constraints on relationships, in venue map data, more accurate or contextually relevant routes can be generated a presented to the user thereby avoiding situations where a user is routed through an inaccessible area of a venue or where the user is frustrated by inaccurate routing. Thus, by defining the relationships between map elements, and constraints on those relationships, in the venue map data, the user experience is improved and user frustration and distress is avoided.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for routing a user through a venue based on map feature relationships.

FIG. 2 is a diagram illustrating relationships that may be defined between an origin feature and a destination feature that allows traversal through a unidirectional opening.

FIG. 3 is a diagram illustrating relationships that may be defined between an origin feature and a destination feature that allows traversal through a bidirectional opening.

FIG. 4 is a diagram illustrating relationships that may be defined between an origin feature and a destination feature that allows traversal through a unidirectional opening where the origin or destination is outside the scope of the venue map.

FIG. 5 is a diagram illustrating relationships that may be defined for an origin feature and a destination feature that allows traversal through a bidirectional opening.

FIG. 6 is a diagram illustrating relationships that may be defined between an origin feature and a destination feature that provides for traversal of a ramp.

FIG. 7 is a diagram illustrating relationships that may be defined between an origin feature and a destination feature that provides for traversal of an escalator.

FIG. 8 is a diagram illustrating relationships that may be defined between an origin feature and a destination feature that provides for traversal of an elevator.

FIG. 9 is a diagram illustrating a relationship that may be defined between an origin feature and a destination feature that provides for a curated traversal path between the origin feature and the destination feature.

FIG. 10 is flow diagram of an example process for venue routing based on map feature relationships.

FIG. 11 is a block diagram of an example computing device that can implement the features and processes of FIGS. 1-10.

Like reference symbols in the various drawings indicate like elements.

### DETAILED DESCRIPTION

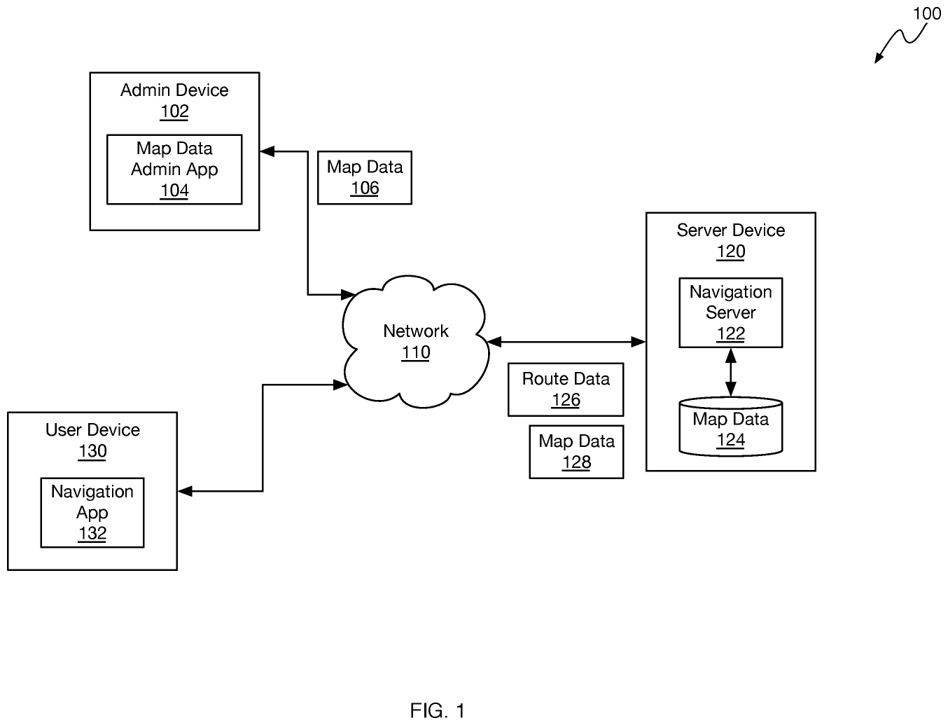

FIG. 1 is a block diagram of an example system 100 for routing a user through a venue based on map feature relationships. For example, system 100 can be used to configure relationships between features (e.g., map elements) in venue map data and/or generate routes between a starting location and a destination location associated with a venue. In this disclosure, a venue is any location, usually enclosed by a perimeter, that does not typically include public streets or highways. Examples of venues include shopping malls, amphitheaters, arenas, parks, school campuses, airports, etc. The venues can be indoors (e.g., an indoor shopping mall), outdoors (e.g., a park), or a combination thereof (e.g., a college campus with multiple buildings separated by outside space, etc.). The features, or map elements, can include rooms, stores, levels of a building, or any other type of space.

The relationship defined for a pair of map features can define how a user may move from an origin feature to a destination feature. When generating a route through a venue, a mapping application may route the user through several map features that have a variety of relationships. For example, the relationship can define a mechanism (e.g., intermediate map feature) through which a user can move from the origin feature to the destination feature. Generally, a route through a venue will be a pedestrian (e.g., walking) route through the venue and may include pedestrian navigation of some pedestrian conveyance (e.g., elevator, moving walkway, escalator, etc.). Thus, a relationship may define, or constrain, how a pedestrian user may move through a venue, as described further below. In some situations, a route through a venue may include vehicular travel using a bicycle, golf cart, scooter, car, bus, etc., such as on a path between buildings within a venue.

The relationship can define constraints on the user's movement from the origin feature to the destination feature. For example, the constraints can include a directional constraint. For example, the user can only move one-way from the origin feature to the destination feature, or two-way between origin and destination. The constraints can include temporal constraints. For example, the user may only move from the origin feature to the destination feature between certain specified hours. The constraints can include security related constraints. For example, the user can only move from origin feature to destination feature if the user has the appropriate security clearance.

To support the characteristics and constraints described herein, each relationship object within the venue map data can include the following properties. For example, a relationship object can have a unique identifier that can be used to identify the specific relationship. A relationship object can have a type identifier that identifies the relationship object as a relationship object. A relationship object can have a geometry property that identifies the location of the relationship object (e.g., may identify a location, may be null) or a curated path of traversal.

A relationship object can include a category property that identifies the relationship category. Relationship categories can include, for example, a “traversal” category (e.g., for openings and doorways), a “ramp” category (e.g., for flat surfaces with a change of elevation or level), an “escalator” category for escalator map features, an “elevator” category for elevator map features, a “traversal path” category for curated paths, and/or other relationship categories such as moving walkways, stairs, etc. While the description that follows provides specific examples of relationships and relationship categories, other or additional relationships and relationship categories can be defined that conform to the data structures, constraints, and/or relationship properties and/or parameters described herein.

A relationship object can include a direction property that identifies the direction in which a user can travel from an origin feature to a destination feature. For example, the direction property can indicate a directed or undirected relationship from the origin feature to the destination feature. If directed, a user may only travel one-way from the origin feature to the destination feature. If undirected, the relationship defines two-way travel between the origin feature and the destination feature.

A relationship object can include properties identifying an origin feature and/or a destination feature. For example, the relationship object must identify, at a minimum, an origin feature or a destination feature. The relationship object may identify both the origin feature and the destination feature when the relationship defines movement between map features within the corresponding venue. The relationship object may identify a null object as a destination or origin when the relationship defines movement outside of the map area defined for the venue, as described further below. The relationship object can include a unique identifier for the origin feature and/or the destination feature. The relationship object can include a type identifier (e.g., “unit”) that identifies the origin feature and/or the destination feature as a space. For example, a “unit” type object models the presence, location, and approximate physical extent of a space. Except where an entrance is modeled using an “opening” type object, the boundary of a unit models the presence of a physical, vertical (e.g., floor-to-ceiling) barrier). Unit objects are map features.

A relationship object can include properties identifying one or more intermediary features. For example, an intermediary feature can be an object or objects through which a user must pass to travel from the origin feature to the destination feature defined in a relationship object. The intermediary feature properties can include a unique identifier for the intermediary feature and a type identifier for the intermediary feature. For example, the type identifier can identify the intermediary feature as an “opening” (e.g., door), a “ramp”, an “escalator”, an “elevator”, a “curated path” or other type of intermediary map feature that may be described herein.

A relationship object can include properties identifying hours of operations constraining the temporal applicability of moving from the destination feature to the origin feature. For example, the hours property can specify a start time and an end time that define a period of time during which a user can move from the origin feature to the destination feature. The hours property can specify a start time and an end time that define a period of time during which a user can move from the origin feature to the destination feature through an intermediary feature if one or more are identified for the relationship object.

A relationship object can include properties identifying security and/or authorization requirements for moving from the origin feature to the destination feature. For example, the security and/or authorization requirements can indicate that only authorized users can move into the destination feature or through the intermediary feature. Alternatively, the security and/or authorization properties can be properties of the destination feature and/or intermediary feature that can be analyzed and accounted for by the mapping application when generating a venue route that includes the destination feature and/or intermediary feature.

In some implementations, system 100 can include administrative device 102. For example, administrative device 102 can be a computing device used for configuring venue map data. Administrative device 102 can include a map data administration application 104 that a map administrator can use to configure map data, including specifying the properties for various relationship objects (e.g., relationships) within a venue, as described above. Map data for a venue may have many relationship objects defined can be used to determine how to navigate and/or generate routes through the venue. After the map data administrator configures the venue map data, including relationship objects, the map data administrator can send the map data (e.g., map data 106) from administrative device 102 to server device 120 through network 110 (e.g., a wireless network, local area network, wide area network, the Internet, etc.).

In some implementations, system 100 can include server device 120. For example, server device 120 can be a computing device configured to generate routes and/or serve map data to client devices, like user device 130). When server device 120 receives map data 106, server device 120 (e.g., navigation server 122) can store map data 106 in map data database 124.

In some implementations, navigation server 122 (e.g., a software server, software module, etc.) can generate routes for a venue. For example, navigation server 122 can receive a route request from a client device (e.g., user device 130) requesting a route through a venue from a starting location to an ending location. Navigation server 122 can generate a route based on the venue map data stored in map data 124. In particular, navigation server 122 can generate a route through the spaces (e.g., units, rooms, buildings, etc.) of the venue based on the relationships defined for the various spaces throughout the venue. For example, navigation server 122 can generate a route from the starting location to the ending location through the venue based on the constraints (e.g., directionality constraints, hours constraints, security constraints, etc.) defined by the various relationships associated with the various spaces within the venue. After generating the route based on the relationships (e.g., properties of the relationship objects associated with the venue map data), navigation server 122 can send, through network 110, the route data 126 to the requesting client device (e.g., user device 130) for presentation to the user. For example, navigation application 132 on user device 130 can present the route defined by route data 126 in a venue map view on a display of user device 130.

In some implementations, instead of generating the route, navigation server 122 can serve map data 128 for a venue to a client device (e.g., user device 130) and the client device can generate and/or present the route through the venue based on map data 128, including the relationships defined for the venue.

In some implementations, system 100 can include user device 130. For example, user device 130 can be a computing device, such as a laptop computer, smartphone, tablet computer, smartwatch, or other wearable device. User device 130 can include navigation application 132 that a user of user device 130 can interact with to request and/or view maps of venues and/or routes through venues. For example, the user can provide input to navigation application 132 specifying a venue and/or a start and end location within the venue. In response to receiving the user input, navigation application 130 can send a request for a route through the venue from the start location to the end location to navigation server 122. Navigation server 122 can generate a route based on the map data for the venue, including the relationships between map features (e.g., units, spaces, rooms, etc.) within the venue. Navigation server 122 can send the generated route to navigation application 132 in route data 126. Navigation application 132 can present the route defined by route data 126 on a map in a map view of navigation application 132 presented on a display of user device 130.

In some implementations, user device 130 can generate routes through a venue based on map data for the venue received from navigation server 122. For example, navigation application 132 can receive user input requesting a route from a start location to a destination through a venue. Navigation application 132 can request map data corresponding to the venue from navigation server 122. Navigation server 122 can send map data 128, including the map data for the venue that defines relationships between map features within the map data. After receiving map data 128, navigation application 132 can generate a route from the start location to the end location through the venue based on the relationship objects defined for the venue. In particular, navigation application 132 can generate a route that accounts for the constraints (e.g., directional constraints, operating hours constraints, security constraints imposed on navigation through the venue by the relationship objects. After generating the route, navigation application 132 can present the route on a map in a map view of navigation application 132 presented on a display of user device 130.

The following figures and paragraphs describe specific examples of relationships and constraints that may be defined for traveling between map features (e.g., units, spaces, rooms, etc.) in a venue. While specific examples are provided below to illustrate the relationship concept disclosed herein, the examples described herein are not intended to be limiting in any way. The specific details, configuration, property values, etc., of the various examples can be combined in different ways to define different relationships in addition to the examples given below. For example, a map administrator may combine the example relationship property values described in the following paragraphs in a new way, or in new combination, to define a relationship that is not explicitly, or specifically, described in the examples that follow.

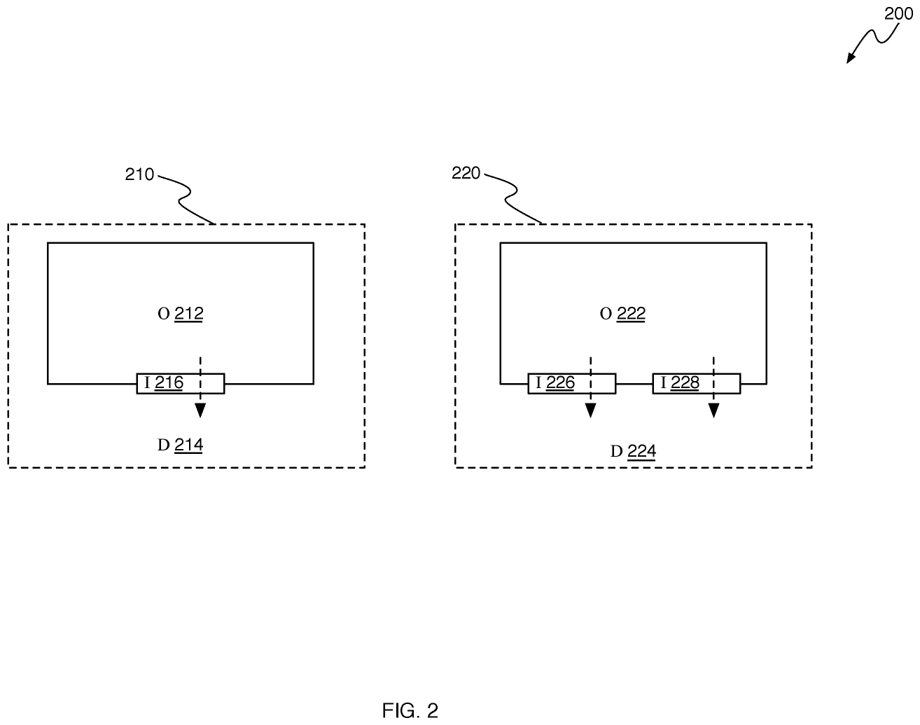

FIG. 2 is a diagram 200 illustrating relationships that may be defined between an origin feature and a destination feature that allows traversal through a unidirectional opening. For example, a relationship object can be configured with properties that restrict or constrain movement between an origin feature and a destination feature such that a route can be generated from, or through, the origin feature to the destination feature but not from the destination feature to the origin feature. In the examples of FIG. 2, the origin feature and the destination feature are both within the scope of the venue map. The following examples include an intermediary feature but similar unidirectional transitions, or relationships, can be configured without an intermediary feature.

The unidirectional relationship object that defines movement through an opening, doorway, etc. (e.g., intermediary object with type “opening) should be defined with the following elements. The unidirectional relationship object should have a category property value of “traversal”, the direction property should have a value of “directed” (e.g., one-way), the intermediary type should have a value of “opening”, should reference units (e.g., spaces, rooms, etc.) on either side of the opening as origin and destination features, and should have a geometry property value of “null” (e.g., no geometry, location, etc.).

Relationship illustration 210 depicts a relationship defining a one-way, or unidirectional relationship between origin feature 212 to destination feature 214 through intermediary feature 216. Origin feature 212 can be, for example, a room or space within a venue, destination feature 214 can be another room or space within the venue connected to origin 212 by intermediary 216 (e.g., an opening, door, etc.). The dashed arrow represents one-way, directed travel only from origin 212 to destination 214 through intermediary 216. When generating a route, navigation server 120 and/or navigation application 132 can detect the directional constraint defined by the relationship and avoid generating a route that requires a user to move from destination 214 to origin 212 through intermediary 216. Conversely, navigation server 120 and/or navigation application 132 can detect the directional constraint defined by the relationship and generate a route, when appropriate, that requires a user to move from origin 212 to destination 214 through intermediary 216.

Relationship illustration 220 depicts a relationship defining a one-way, or unidirectional relationship between origin feature 222 to destination feature 224 through two (or more) intermediary features 226 and 228. Origin feature 222 can be, for example, a room or space within a venue, destination feature 224 can be another room or space within the venue connected to origin 222 by intermediaries 226 and 228 (e.g., an opening, door, etc.). The dashed arrows represent one-way, directed travel only from origin 222 to destination 224 through intermediary 226 or intermediary 228. Since the two intermediaries create two different relationships between origin 222 and destination 224, the map data for the venue can include separate relationship definitions based on each intermediary 226 and 228. When generating a route, navigation server 120 and/or navigation application 132 can detect the directional constraints defined by the relationships and avoid generating a route that requires a user to move from destination 224 to origin 222 through intermediary 226 or intermediary 228. Conversely, navigation server 120 and/or navigation application 132 can detect the directional constraint defined by the relationships and generate a route, when appropriate, that requires a user to move from origin 222 to destination 224 through intermediary 226 or intermediary 228.

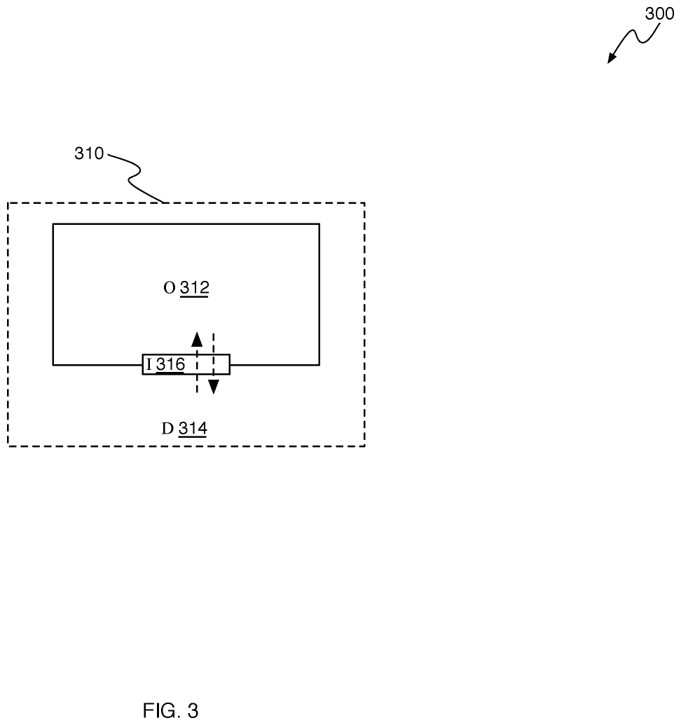

FIG. 3 is a diagram 300 illustrating relationships that may be defined between an origin feature and a destination feature that allows traversal through a bidirectional opening. For example, a relationship object can be configured with properties that do not include a directional constraint on movement between an origin feature and a destination feature such that a route can be generated from, or through, the origin feature to the destination feature and/or from the destination feature to the origin feature. In the examples of FIG. 3, the origin feature and the destination feature are both within the scope of the venue map. The following examples include an intermediary feature but similar unidirectional transitions, or relationships, can be configured without an intermediary feature.

The bidirectional relationship object that defines movement through an opening, doorway, etc. (e.g., intermediary object with type “opening) should be defined with the following elements. The bidirectional relationship object should have a category property value of “traversal”, the direction property should have a value of “undirected” (e.g., two-way), the intermediary type should have a value of “opening”, should reference units (e.g., spaces, rooms, etc.) on either side of the opening as origin and destination features, and should have a geometry property value of “null” (e.g., no geometry, location, etc.).

Relationship illustration 310 depicts a relationship defining a two-way, or bidirectional, undirected relationship between origin feature 312 to destination feature 314 through intermediary feature 316. Origin feature 312 can be, for example, a room or space within a venue, destination feature 314 can be another room or space within the venue connected to origin 312 by intermediary 316 (e.g., an opening, door, etc.). The dashed arrows represent two-way, undirected travel between origin 312 and destination 314 through intermediary 316. When generating a route, navigation server 120 and/or navigation application 132 can determine that movement between origin 312 and destination 314 through intermediary 312 is unconstrained by the relationship and generate a route that requires a user to move from destination 314 to origin 312 through intermediary 316 or from origin 312 to destination 314 through intermediary 316.

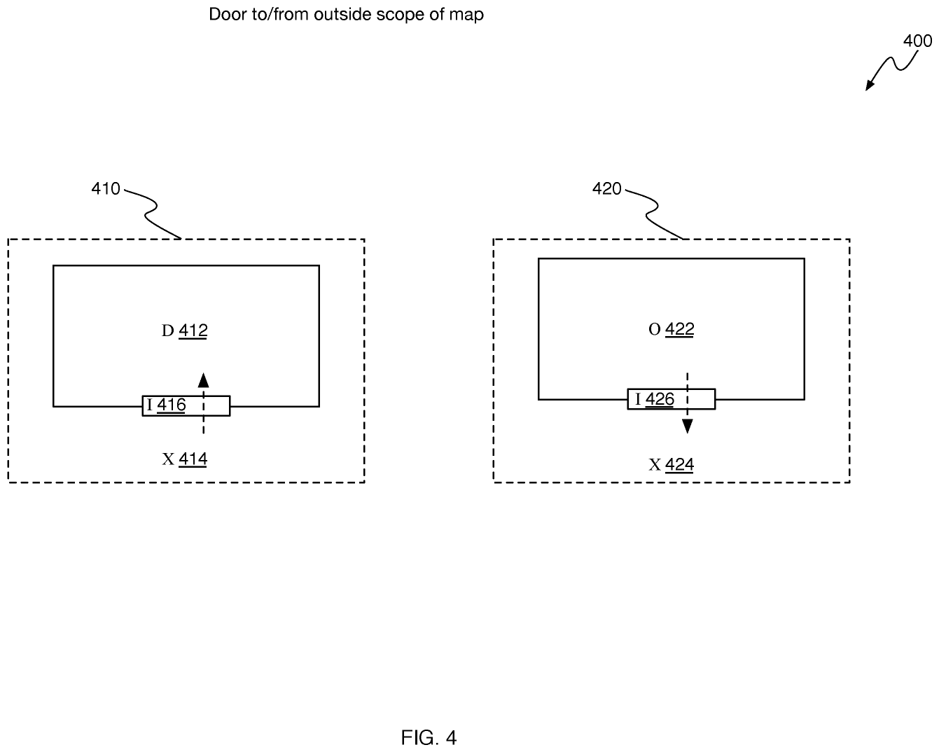

FIG. 4 is a diagram 400 illustrating relationships that may be defined between an origin feature and a destination feature that allows traversal through a unidirectional opening where the origin or destination is outside the scope of the venue map. For example, a relationship object can be configured with properties that restrict or constrain movement between an origin feature and a destination feature such that a route can be generated from, or through, the origin feature to the destination feature but not from the destination feature to the origin feature. In the relationship example 410, the origin feature is outside the scope of the venue map while the destination feature is within the scope of the venue map. In the relationship example 420, the destination feature is outside the scope of the venue map while the origin feature is within the scope of the venue map. For example, these relationships allow navigation server 120 or navigation application 132 to generate a route that guides a user into a venue from an outside location or out of the venue from an inside location. The following examples include an intermediary feature but similar unidirectional transitions, or relationships, can be configured without an intermediary feature.

The unidirectional relationship object that defines movement through an opening, doorway, etc. (e.g., intermediary object with type “opening) should be defined with the following elements. The unidirectional relationship object should have a category property value of “traversal”, the direction property should have a value of “directed” (e.g., one-way), the intermediary type should have a value of “opening”, should reference units (e.g., spaces, rooms, etc.) on either side of the opening as origin and destination features, and should have a geometry property value of “null” (e.g., no geometry, location, etc.). When the origin or destination is outside the scope of the venue map, the origin feature or destination feature that is outside the scope of the venue map may be assigned a “null” value. Either the origin feature or the destination feature in the same relationship may be assigned a “null” value but not both.

Relationship illustration 410 depicts a relationship defining a one-way, or unidirectional relationship between origin feature 414 (X indicates outside scope of map, or null value) to destination feature 412 through intermediary feature 416. Origin feature 414 can be, for example, a location outside the scope of the venue, destination feature 412 can be a unit (e.g., room or space) within the venue connected to origin 414 by intermediary 416 (e.g., an opening, door, etc.). The dashed arrow represents one-way, directed travel only from origin 414 to destination 411 through intermediary 416. When generating a route, navigation server 120 and/or navigation application 132 can detect the directional constraint defined by the relationship and avoid generating a route that requires a user to move from destination 412 to origin 414 through intermediary 416. Conversely, navigation server 120 and/or navigation application 132 can detect the directional constraint defined by the relationship and generate a route, when appropriate, that requires a user to move from origin 414 to destination 412 through intermediary 416.

Relationship illustration 420 depicts a relationship defining a one-way, or unidirectional relationship between origin feature 422 to destination feature 424 (X indicates outside scope of map, or null value) through intermediary feature 426. Origin feature 422 can be a unit (e.g., room or space) within the venue, destination feature 424 can be, for example, a location outside the scope of the venue connected to origin 422 by intermediary 426 (e.g., an opening, door, etc.). The dashed arrow represents one-way, directed travel only from origin 422 to destination 424 through intermediary 426. When generating a route, navigation server 120 and/or navigation application 132 can detect the directional constraint defined by the relationship and avoid generating a route that requires a user to move from destination 424 to origin 422 through intermediary 426. Conversely, navigation server 120 and/or navigation application 132 can detect the directional constraint defined by the relationship and generate a route, when appropriate, that requires a user to move from origin 422 to destination 424 through intermediary 426.

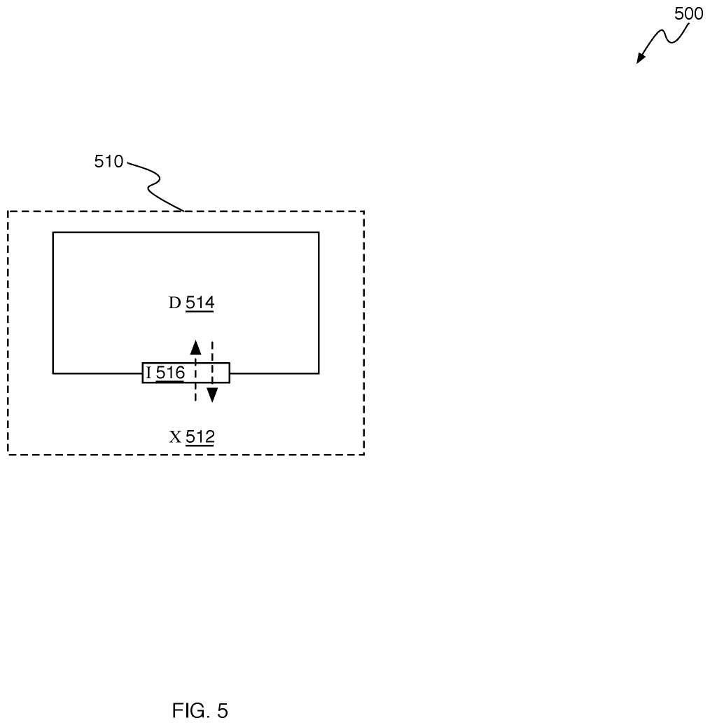

FIG. 5 is a diagram 500 illustrating relationships that may be defined for an origin feature and a destination feature that allows traversal through a bidirectional opening. For example, a relationship object can be configured with properties that do not include a directional constraint on movement between an origin feature and a destination feature such that a route can be generated from, or through, the origin feature to the destination feature and/or from the destination feature to the origin feature. In the example of FIG. 5, the origin feature (or the destination feature) may be outside the scope of the venue map. The following examples include an intermediary feature but similar unidirectional transitions, or relationships, can be configured without an intermediary feature.

The bidirectional relationship object that defines movement through an opening, doorway, etc. (e.g., intermediary object with type “opening”) should be defined with the following elements. The bidirectional relationship object should have a category property value of “traversal”, the direction property should have a value of “undirected” (e.g., two-way), the intermediary type should have a value of “opening”, should reference units (e.g., spaces, rooms, etc.) on either side of the opening as origin and destination features, and should have a geometry property value of “null” (e.g., no geometry, location, etc.). When the origin feature or the destination feature is outside the scope of the venue map, the feature outside the scope of the map can be assigned a “null” value. The origin feature or the destination feature can be assigned a null value, but not both.

Relationship illustration 510 depicts a relationship defining a two-way, or bidirectional, undirected relationship between origin feature 512 (X indicates outside scope of map, or null value) to destination feature 514 through intermediary feature 516. Origin feature 512 can be, for example, outside the scope of the venue map, destination feature 514 can be a room or space within the venue connected to origin 512 by intermediary 516 (e.g., an opening, door, etc.). The dashed arrows represent two-way, undirected travel between origin 512 and destination 514 through intermediary 516. When generating a route, navigation server 120 and/or navigation application 132 can determine that movement between origin 512 and destination 514 through intermediary 512 is unconstrained by the relationship and generate a route that requires a user to move from destination 514 to origin 512 through intermediary 516 or from origin 512 to destination 514 through intermediary 516.

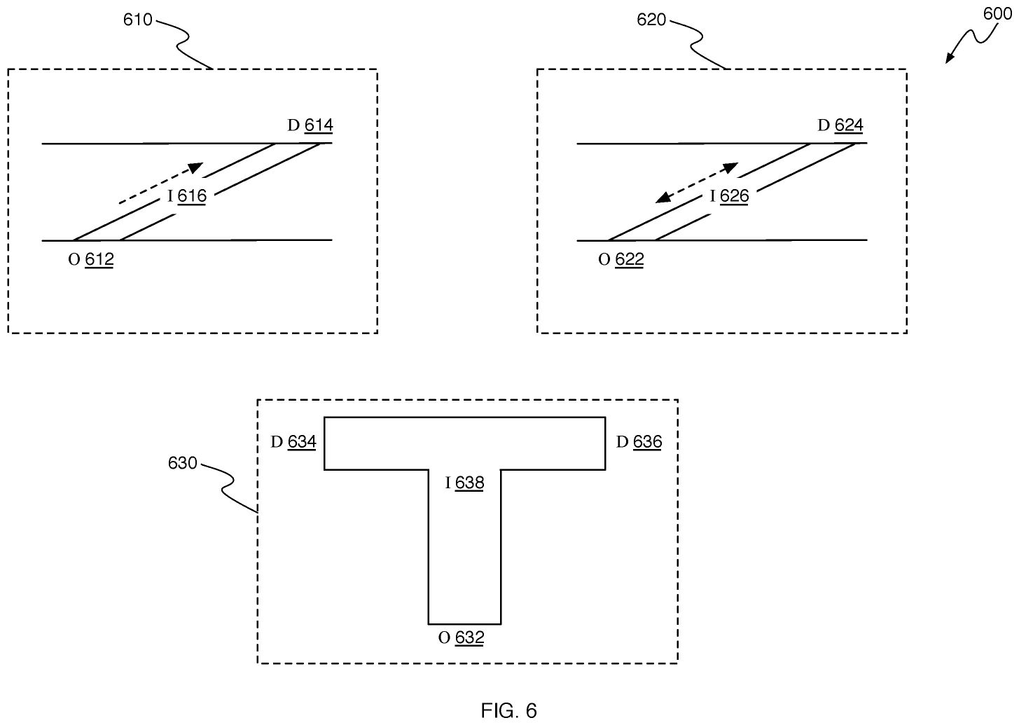

FIG. 6 is a diagram 600 illustrating relationships that may be defined between an origin feature and a destination feature that provides for traversal of a ramp. For example, a ramp may allow movement from an origin feature at one level of a building or structure to another level of the building or structure. Relationships through ramps should have a relationship category value of “ramp”. Relationships that include ramps can be directed (e.g., one-way, unidirectional) or undirected (e.g., two-ways, bidirectional). Relationships that include ramps should reference a “ramp” unit as the intermediary feature and should reference the openings of the ramp as the origin feature and the destination feature. Relationships that include ramps should have a null geometry value.

Relationship illustration 610 depicts a relationship defining a directed relationship between origin feature 612 (e.g., a threshold at a first end of the ramp) to destination feature 614 (e.g., a threshold at a second end of the ramp) through intermediary feature 616 (e.g., a unit defining the space corresponding to the ramp). The dashed arrow represents one-way, directed travel between origin 612 and destination 614 through intermediary 616. When generating a route, navigation server 120 and/or navigation application 132 can determine that movement between origin 612 and destination 614 through intermediary 612 is constrained by the directionality of the relationship and generate a route that avoids requiring a user to move from destination 614 to origin 612 through intermediary 616. Conversely, navigation server 120 and/or navigation application 132 can determine that movement from origin 612 to destination 614 through intermediary 612 is allowed by the directionality of the relationship and generate a route that requires a user to move from origin 612 to destination 614 through intermediary 616.

Relationship illustration 620 depicts a relationship defining an undirected relationship between origin feature 622 (e.g., a threshold at a first end of the ramp) to destination feature 624 (e.g., a threshold at a second end of the ramp) through intermediary feature 626 (e.g., a unit defining the space corresponding to the ramp). The dashed arrow represents two-way, undirected travel between origin 622 and destination 624 through intermediary 626. When generating a route, navigation server 120 and/or navigation application 132 can determine that movement between origin 622 and destination 624 through intermediary 626 is unconstrained and generate a route that requires a user to move from destination 624 to origin 622 through intermediary 626 or from origin 622 to destination 624 through intermediary 626.

Relationship illustration 630 depicts a ramp relationship that has multiple destinations. For example, a ramp relationship may include a ramp (intermediary 638) that has a single origin feature 632 and two destination features 634 and 636. Like the multiple doorway or opening illustration 220 of FIG. 2, the multiple destinations (or origins) of the ramp can be modeled in the venue map data by generating separate, distinct relationships for each destination. Thus, the venue map data can be configured with a ramp relationship that includes origin 632, intermediary 638, and destination 634. The venue map data can also be configured with a ramp relationship that includes origin 632, intermediary 638, and destination 636. When generating a route, navigation server 120 and/or navigation application 132 can determine a route based on the ramp relationship that includes destination 634 or destination 634 based on whichever destination is required to generate the best route through the venue.

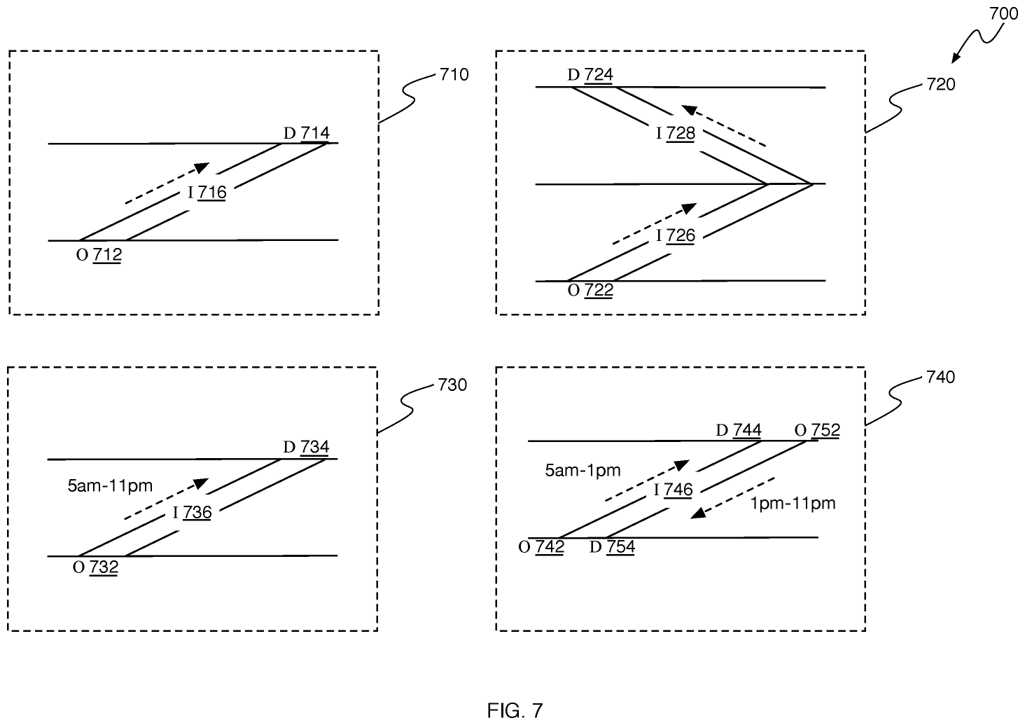

FIG. 7 is a diagram 700 illustrating relationships that may be defined between an origin feature and a destination feature that provides for traversal of an escalator. For example, an escalator may allow movement from an origin feature at one level of a building or structure to another level of the building or structure. Relationships through escalators should have a relationship category value of “escalator”. Relationships that include escalator can be directed (e.g., one-way, unidirectional) or undirected (e.g., two-ways, bidirectional). Relationships that include escalators should reference an “escalator” unit as the intermediary feature (or features) and should reference the openings (e.g., kickplate) of the escalator as the origin feature and the destination feature. Relationships that include elevators should have a null geometry value.

Relationship illustration 710 depicts a relationship defining a directed relationship between origin feature 712 (e.g., an opening/kickplate at a first end of the escalator) to destination feature 714 (e.g., an opening/kickplate at a second end of the escalator) through intermediary feature 716 (e.g., a unit defining the space corresponding to the escalator). The dashed arrow represents one-way, directed travel between origin 712 and destination 714 through intermediary 716. When generating a route, navigation server 120 and/or navigation application 132 can determine that movement between origin 712 and destination 714 through intermediary 716 is constrained by the directionality of the relationship and generate a route that avoids requiring a user to move from destination 714 to origin 712 through intermediary 716. Conversely, navigation server 120 and/or navigation application 132 can determine that movement from origin 712 to destination 714 through intermediary 716 is allowed based on the directionality of the relationship and generate a route that requires a user to move from origin 712 to destination 714 through intermediary 716.

Relationship illustration 720 depicts a relationship defining a directed relationship between origin feature 722 (e.g., an opening/kickplate at a first end of the first escalator) to destination feature 724 (e.g., an opening/kickplate at a second end of the second escalator) through multiple intermediary features 726 and 728 (e.g., units defining the spaces corresponding to the escalators). The dashed arrows represent one-way, directed travel between origin 722 and destination 724 through intermediary 726. The multiple escalators allow access to multiple levels in a building or structure and may be configured in the relationship between origin 722 and destination 724 as multiple intermediaries in the same relationship object. When generating a route, navigation server 120 and/or navigation application 132 can determine that movement between origin 722 and destination 724 through intermediaries 726 and 728 is constrained by the directionality of the relationship and generate a route that avoids requiring a user to move from destination 724 to origin 722 through intermediary 726 and intermediary 728. Conversely, navigation server 120 and/or navigation application 132 can determine that movement from origin 722 to destination 724 through intermediary 726 and intermediary 728 is allowed based on the directionality of the relationship and generate a route that requires a user to move from origin 722 to destination 724 through intermediary 726 and intermediary 728.

Relationship illustration 730 depicts a relationship defining a directed relationship between origin feature 732 (e.g., an opening/kickplate at a first end of the escalator) to destination feature 734 (e.g., an opening/kickplate at a second end of the escalator) through intermediary feature 736 (e.g., a unit defining the space corresponding to the escalator). The dashed arrow represents one-way, directed travel between origin 732 and destination 734 through intermediary 736. Additionally, movement through intermediary 736 is further constrained by a time constraint. For example, the definition for the relationship between origin 732 and destination 734 through intermediary 736 can specify operating hours (e.g., 5 am-7 pm) during which users may be routed from origin 732 to destination 734 through intermediary 736. When generating a route, navigation server 120 and/or navigation application 132 can determine that movement between origin 732 and destination 734 through intermediary 736 is constrained not only by the directionality of the relationship but also by the operating hours of the escalator and generate a route that avoids requiring a user to move from origin 732 to destination 734 through intermediary 736 outside of the operating hours. Conversely, navigation server 120 and/or navigation application 132 can determine that movement from origin 732 to destination 734 through intermediary 736 is allowed during the operating hours based on the directionality of the relationship and the specified operation hours and may generate a route that requires a user to move from origin 732 to destination 734 through intermediary 736 during the specified operating hours. Although this is the first relationship example to include operating hours, operating hours can be a constraint configured for and applied to any of the relationships described herein.

Relationship illustration 740 depicts a relationship defining a directed relationship between origin feature 742/752 (e.g., an opening/kickplate at a first end of the escalator) to destination feature 744/754 (e.g., an opening/kickplate at a second end of the escalator) through intermediary feature 746 (e.g., a unit defining the space corresponding to the escalator). Although the dashed arrows in this example appear to indicate two-way, bidirectional travel, the dashed arrows actually represent one-way, directed travel between origin 742/752 and destination 744/754 through intermediary 746 during specified operating hours. For example, to account for the different directions of travel at different hours, the venue map data may be configured with two different relationship definitions: one that allows travelling from origin 742 and destination 744 through intermediary 746 during a first specified operating hours, and another that allows that allows travelling from origin 752 and destination 754 through intermediary 746 during second specified operating hours. For example, the first relationship definition (e.g., relationship object) may specify that the relationship between origin 742 to destination 744 through intermediary 746 during the operating hours (e.g., which may include times during a day and/or days of the week) of 5 am-1 pm is a one-way, directed relationship from origin 742 to destination 744. Another relationship definition (e.g., relationship object) may specify that the relationship between origin 752 to destination 754 through intermediary 746 during the operating hours (e.g., which may include times during a day and/or days of the week) of 1 pm-11 pm is a one-way, directed relationship from origin 752 to destination 754. Thus, one entrance to the escalator can be identified as origin and destination in different relationship definitions. When generating a route, navigation server 120 and/or navigation application 132 can determine that movement between origin 742/752 and destination 744/754 through intermediary 746 is constrained not only by the directionality of the relationships but also by the operating hours of the relationship (e.g., operating hours of the escalator) and generate a route that avoids requiring a user to move from origin 742/752 to destination 744/754 through intermediary 746 outside of the operating hours. Conversely, navigation server 120 and/or navigation application 132 can determine that movement from origin 742/752 to destination 744/754 through intermediary 746 is allowed during the operating hours based on the directionality of the relationship and generate a route that requires a user to move from origin 742/752 to destination 744/754 through intermediary 746 during the specified operating hours.

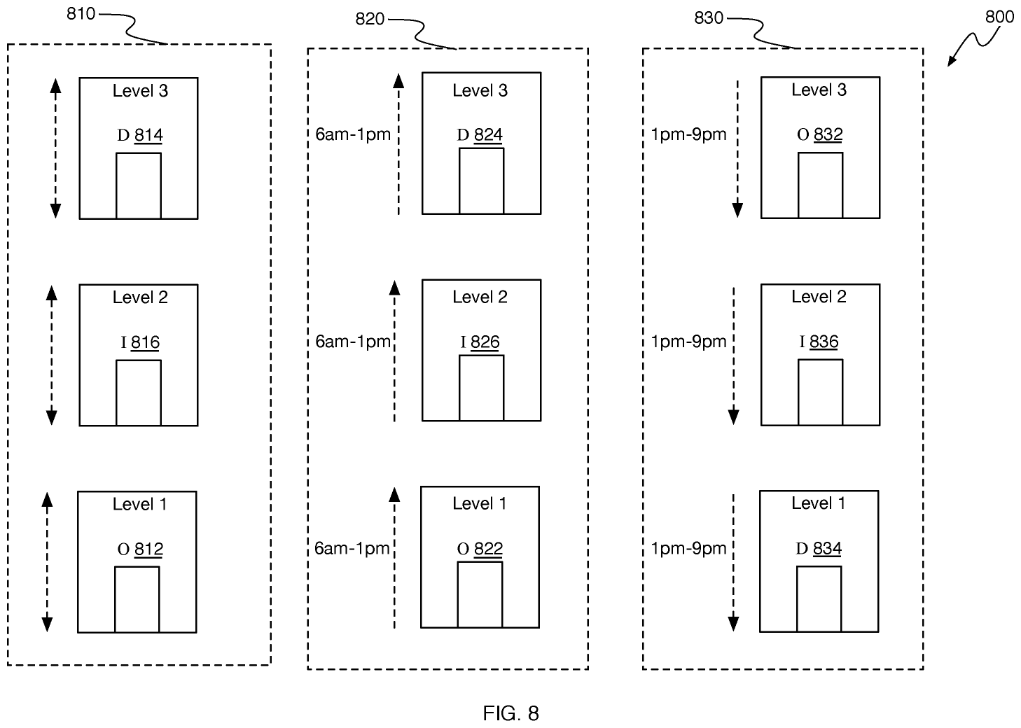

FIG. 8 is a diagram 800 illustrating relationships that may be defined between an origin feature and a destination feature that provides for traversal of an elevator. For example, an elevator may allow movement from an origin feature at one level of a building or structure to a destination feature at another level of the building or structure. Relationships through elevators should have a relationship category value of “elevator”. Relationships that include an elevator can be directed (e.g., one-way, unidirectional) or undirected (e.g., two-ways, bidirectional). Relationships that include elevators should reference an “elevator” unit as the intermediary feature (or features) and may reference an elevator at one end of the range of travel of the elevator as the origin feature and elevator at the other end of the range of travel as the destination feature. Relationships that include elevators should have a null geometry value.

Relationship illustration 810 depicts a relationship defining an undirected relationship between origin feature 812 (e.g., an elevator unit at the lowest level to which the elevator travels) to destination feature 814 (e.g., an elevator unit at the highest level to which the elevator travels) through intermediary feature 816 (e.g., elevators at intermediate levels or floors between origin and destination elevators). When multiple the elevator travels to multiple levels between the origin level and the destination level, the relationship object can include multiple intermediary elevators 816. The dashed arrow represents two-way, directed travel between origin 812 and destination 814 through intermediary 816. When generating a route, navigation server 120 and/or navigation application 132 can determine that movement between origin 812 and destination 814 through intermediary 816 is directionally unconstrained and may generate a route that requires a user to move from destination 814 to origin 812 through intermediary 816 or from origin 812 to destination 814 through intermediary 816.

Relationship illustration 820 depicts a relationship defining an directed relationship between origin feature 822 (e.g., an elevator unit at the lowest level to which the elevator travels) to destination feature 824 (e.g., an elevator unit at the highest level to which the elevator travels) through intermediary feature 826 (e.g., elevators at intermediate levels or floors between origin and destination elevators). When multiple the elevator travels to multiple levels between the origin level and the destination level, the relationship object can include multiple intermediary elevators 826 representing the levels between the origin feature 822 and destination feature 824. For example, when an elevator stops at all levels between origin feature 822 and destination feature 824, the relationship can include an intermediary feature 826 (e.g., intermediary elevator) for all of the levels between the origin feature 822 and destination feature 824. When an elevator skips one or more levels between origin feature 822 and destination feature 824, the relationship can include an intermediary feature 826 (e.g., intermediary elevator) for all of the levels at which the elevator stops and exclude an intermediary feature 826 for each skipped level between the origin feature 822 and destination feature 824. The dashed arrow represents one-way, directed travel between origin 822 and destination 824 through intermediary 826 during specified operating hours. For example, in an office building, some elevators may be configured to only move up through the building in the morning to allow office workers to quickly get to their offices, while in towards the end of the day some elevators may be configured to move down through the building to allow the office workers to quickly leave at the end of the day. When generating a route, navigation server 120 and/or navigation application 132 can determine that movement between origin 822 and destination 824 through intermediary 826 is directionally constrained during the specified operating hours such that a user can only travel upward from origin 822 to destination 824 and may avoid generating a route that requires a user to move from destination 824 to origin 822 through intermediary 826 during the operating hours. Conversely, navigation server 120 and/or navigation application 132 can determine that movement between origin 822 and destination 824 through intermediary 826 is directionally constrained during the specified operating hours such that a user can only travel upward from origin 822 to destination 824 and may generate a route that requires a user to move from or from origin 822 to destination 824 through intermediary 826 during the specified office hours.

Relationship illustration 830 depicts a relationship defining an directed relationship between origin feature 832 (e.g., an elevator unit at the highest level to which the elevator travels) to destination feature 834 (e.g., an elevator unit at the lowest level to which the elevator travels) through intermediary feature 826 (e.g., elevators at intermediate levels or floors between origin and destination elevators). When multiple the elevator travels to multiple levels between the origin level and the destination level, the relationship object can include multiple intermediary elevators 836. The dashed arrow represents one-way, directed travel between origin 832 and destination 834 through intermediary 836 during specified operating hours. For example, in an office building, some elevators may be configured to only move up through the building in the morning to allow office workers to quickly get to their offices, while in towards the end of the day some elevators may be configured to move down through the building to allow the office workers to quickly leave at the end of the day. When generating a route, navigation server 120 and/or navigation application 132 can determine that movement between origin 832 and destination 834 through intermediary 836 is directionally constrained during the specified operating hours such that a user can only travel downward from origin 832 to destination 834 and may avoid generating a route that requires a user to move from destination 834 to origin 832 through intermediary 836 during the operating hours. Conversely, navigation server 120 and/or navigation application 132 can determine that movement between origin 832 and destination 834 through intermediary 836 is directionally constrained during the specified operating hours such that a user can only travel downward from origin 832 to destination 834 and may generate a route that requires a user to move from or from origin 832 to destination 834 through intermediary 836 during the specified office hours.

In some venue configurations, the relationships illustrated by 810, 820, and/or 830 can be combined to allow navigation server 120 and/or navigation application 132 to generate different routes through the same set of elevators at different times. For example, in an office building, some elevators may be configured to only move up through the building in the morning (e.g., relationship illustration/configuration 820) to allow office workers to quickly get to their offices, while towards the end of the day (e.g., relationship illustration/configuration 830) some elevators may be configured to move down through the building to allow the office workers to quickly leave at the end of the day, while on the weekend the same set of elevators may be configured to move bidirectionally through the levels of the building (e.g., relationship illustration/configuration 810 when also configured with operating hours). Thus, multiple relationship objects (e.g., multiple relationships) can be defined that include the same conveyance, walkway, staircase, etc., but that described different usage restrictions or constraints at different times.

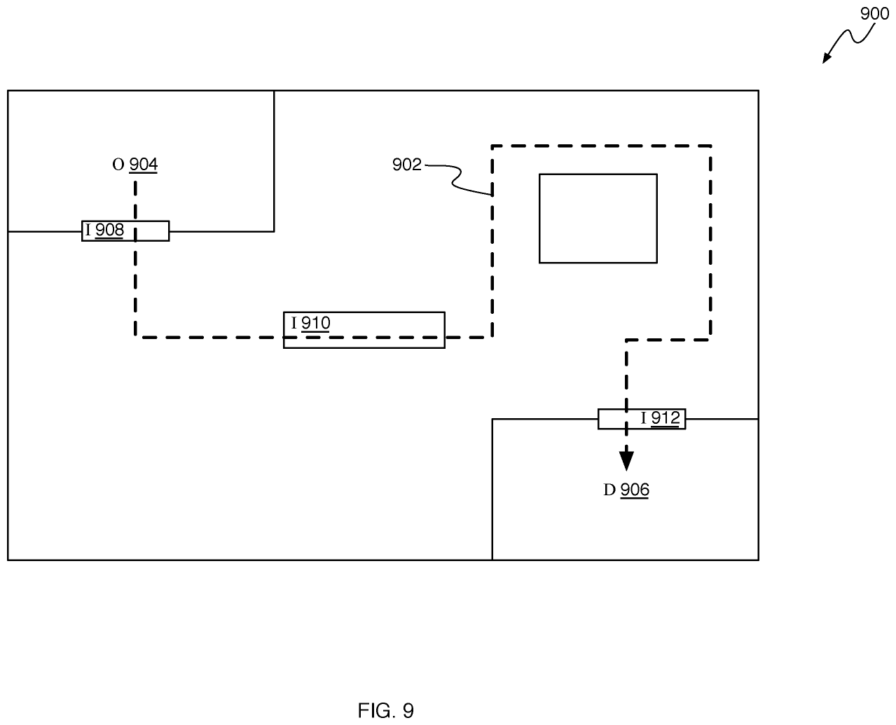

FIG. 9 is a diagram 900 illustrating a relationship that may be defined between an origin feature and a destination feature that provides for a curated traversal path between the origin feature and the destination feature. For example, a curated path can be a predefined, administrative user generated path from an origin feature (e.g., a room, location, etc.) within a venue to a destination feature within the venue. Relationships that include curated paths should have a relationship category value of “traversal path”. Relationships that include a curated path can be directed (e.g., one-way, unidirectional) or undirected (e.g., two-ways, bidirectional). Relationships that include curated paths should include a linear geometry value through locations between the origin feature and the destination feature representing the curated path of traversal.

In some implementations, a curated path 902 can be defined through a venue from origin feature 904 to destination feature 906. The curated path 902 can pass through one or more intermediaries 908, 910, and/or 912. Thus, the relationship object associated with the curated path can include a reference to origin 904, destination 906, curated path 902 and/or one or more of the intermediaries 908, 910 and/or 912. When generating a route through origin feature 904 to destination feature 906, navigation server 120 and/or navigation application 132 can determine the origin feature 904 and destination feature 906 have a curated path relationship and include, or recommend, the curated path when generating a route from origin feature 904 to destination feature 906.

### Example Processes

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

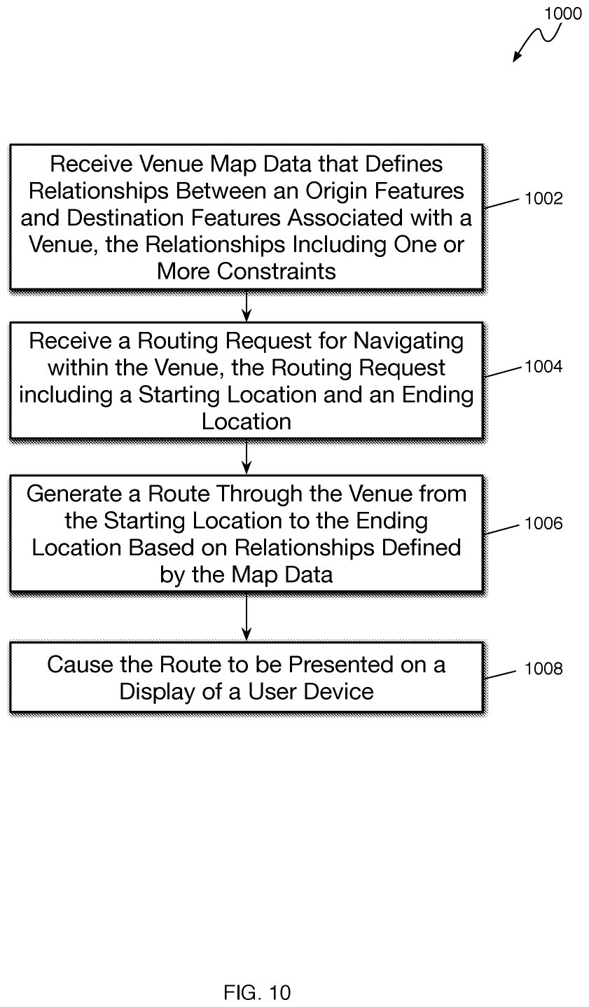

FIG. 10 is flow diagram of an example process 1000 for venue routing based on map feature relationships. For example, process 1000 can be performed by navigation server 122 on server device 120 or navigation application 132 on user device 130. Process 1000 can be performed to generate a route through a venue based on various relationships (e.g., relationship objects) between map features (e.g., spaces, rooms, areas, etc.) defined in the venue map data. For example, a computing device (e.g., server device 120, user device 130) can determine whether to route a user through one or more related pairs of map features based on the relationship object, and any constraints defined in the relationship object, defined for the related map features.

At step 1002, a computing device can receive venue map data that defines relationships between origin features and destination features associated with a venue. As described above, the venue map data can include relationship objects that define relationships between an origin map feature and a destination map feature. The relationship objects can define directional constraints. For example, the relationship objects can specify one-way movement from origin feature to destination feature or two-way movement between origin feature and destination feature. The relationship objects can define temporal constraints. For example, the relationship objects can define hours of operations during which a user can be routed from the origin feature to the destination feature. The relationship object can define security constraints. For example, the relationship object can indicate that only certain types of users can move from the origin feature to the destination feature identified in the relationship object.

At step 1004, the computing device can receive a routing request for navigating within the venue. For example, the routing request can be received via user input to a user device or, in the case of the server generated route, through a network connection from a user device. The routing request can identify the venue through which a route is desired and a starting location and an ending location. For example, the starting location can be the current location of the user device and the ending location can be a user specified destination.

At step 1006, the computing device can generate a route through the venue from the starting location to the ending location. For example, the route through the venue can be determined and/or generated based on the relationship objects defined in the map data. For example, the computing device can analyze the constraints defined by the various relationship objects to determine whether the computing device can route a user through the origin feature and the destination feature associated with the relationships. Thus, even though a route through a particular origin feature-destination feature pair may be the most efficient route, the constraints defined for the origin feature-destination feature relationship may not allow the computing device to generate a route through the particular origin feature-destination feature pair. The computing device may analyze multiple relationship objects to generate a route that complies with all of the constraints defined for the relationship objects associated with the venue.

At step 1008, the computing device can cause the route to be presented on a display of a user device. For example, after generating a route that complies with all of the relationship object constraints for relevant map features along the route, the computing device can cause the route to be presented on the display of the user device. For example, when server device 120 generates the route, server device 120 can send the generated route to user device 130 in route data 126. When user device 130 receives route data 126, user device 130 can present the route defined by route data 126 on a display of user device 130. When user device 130 generates the route based on map data 128 for the venue received from server device 120, user device 130 can present the generated route on a display of user device 130 so that the user can navigate the generated route through the venue.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

As described above, one aspect of the present technology is the gathering and use of data available from various sources to generate routes through a venue. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to generate appropriate routes through a venue that are most useful to the user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of venue routing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, venue routes can be generated based on non-personal information data or a bare minimum amount of personal information, such as the content being requested by the device associated with a user, other non-personal information available to the navigation processes, or publicly available information.

### Example System Architecture

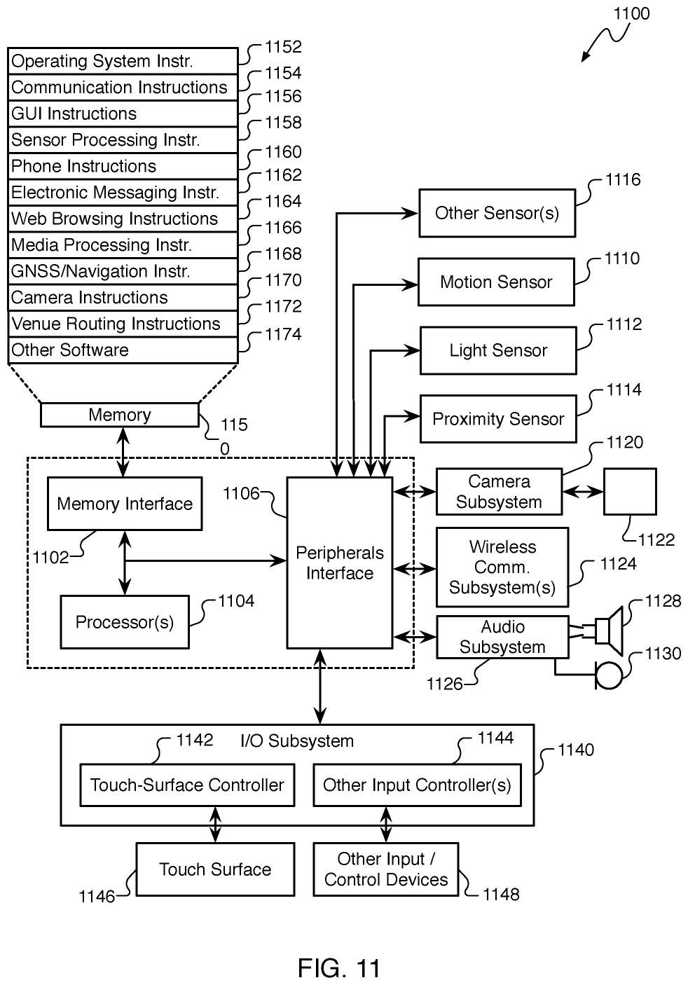

FIG. 11 is a block diagram of an example computing device 1100 that can implement the features and processes of FIGS. 1-10. The computing device 1100 can include a memory interface 1102, one or more data processors, image processors and/or central processing units 1104, and a peripherals interface 1106. The memory interface 1102, the one or more processors 1104 and/or the peripherals interface 1106 can be separate components or can be integrated in one or more integrated circuits. The various components in the computing device 1100 can be coupled by one or more communication buses or signal lines.

Sensors, devices, and subsystems can be coupled to the peripherals interface 1106 to facilitate multiple functionalities. For example, a motion sensor 1110, a light sensor 1112, and a proximity sensor 1114 can be coupled to the peripherals interface 1106 to facilitate orientation, lighting, and proximity functions. Other sensors 1116 can also be connected to the peripherals interface 1106, such as a global navigation satellite system (GNSS) (e.g., GPS receiver), a temperature sensor, a biometric sensor, magnetometer or other sensing device, to facilitate related functionalities.

A camera subsystem 1120 and an optical sensor 1122, e.g., a charged coupled device (CCD) or a complementary metal-oxide semiconductor (CMOS) optical sensor, can be utilized to facilitate camera functions, such as recording photographs and video clips. The camera subsystem 1120 and the optical sensor 1122 can be used to collect images of a user to be used during authentication of a user, e.g., by performing facial recognition analysis.

Communication functions can be facilitated through one or more wireless communication subsystems 1124, which can include radio frequency receivers and transmitters and/or optical (e.g., infrared) receivers and transmitters. The specific design and implementation of the communication subsystem 1124 can depend on the communication network(s) over which the computing device 1100 is intended to operate. For example, the computing device 1100 can include communication subsystems 1124 designed to operate over a GSM network, a GPRS network, an EDGE network, a Wi-Fi or WiMax network, and a Bluetooth™ network. In particular, the wireless communication subsystems 1124 can include hosting protocols such that the device 100 can be configured as a base station for other wireless devices.

An audio subsystem 1126 can be coupled to a speaker 1128 and a microphone 1130 to facilitate voice-enabled functions, such as speaker recognition, voice replication, digital recording, and telephony functions. The audio subsystem 1126 can be configured to facilitate processing voice commands, voiceprinting and voice authentication, for example.

The I/O subsystem 1140 can include a touch-surface controller 1142 and/or other input controller(s) 1144. The touch-surface controller 1142 can be coupled to a touch surface 1146. The touch surface 1146 and touch-surface controller 1142 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1146.

The other input controller(s) 1144 can be coupled to other input/control devices 1148, such as one or more buttons, rocker switches, thumb-wheel, infrared port, USB port, and/or a pointer device such as a stylus. The one or more buttons (not shown) can include an up/down button for volume control of the speaker 1128 and/or the microphone 1130.

In one implementation, a pressing of the button for a first duration can disengage a lock of the touch surface 1146; and a pressing of the button for a second duration that is longer than the first duration can turn power to the computing device 1100 on or off. Pressing the button for a third duration can activate a voice control, or voice command, module that enables the user to speak commands into the microphone 1130 to cause the device to execute the spoken command. The user can customize a functionality of one or more of the buttons. The touch surface 1146 can, for example, also be used to implement virtual or soft buttons and/or a keyboard.

In some implementations, the computing device 1100 can present recorded audio and/or video files, such as MP3, AAC, and MPEG files. In some implementations, the computing device 1100 can include the functionality of an MP3 player, such as an iPod™.

The memory interface 1102 can be coupled to memory 1150. The memory 1150 can include high-speed random-access memory and/or non-volatile memory, such as one or more magnetic disk storage devices, one or more optical storage devices, and/or flash memory (e.g., NAND, NOR). The memory 1150 can store an operating system 1152, such as Darwin, RTXC, LINUX, UNIX, OS X, WINDOWS, or an embedded operating system such as VxWorks.

The operating system 1152 can include instructions for handling basic system services and for performing hardware dependent tasks. In some implementations, the operating system 1152 can be a kernel (e.g., UNIX kernel). In some implementations, the operating system 1152 can include instructions for performing venue routing based on map feature relationships. For example, operating system 1152 can implement the venue routing features as described with reference to FIGS. 1-10.

The memory 1150 can also store communication instructions 1154 to facilitate communicating with one or more additional devices, one or more computers and/or one or more servers. The memory 1150 can include graphical user interface instructions 1156 to facilitate graphic user interface processing; sensor processing instructions 1158 to facilitate sensor-related processing and functions; phone instructions 1160 to facilitate phone-related processes and functions; electronic messaging instructions 1162 to facilitate electronic-messaging related processes and functions; web browsing instructions 1164 to facilitate web browsing-related processes and functions; media processing instructions 1166 to facilitate media processing-related processes and functions; GNSS/Navigation instructions 1168 to facilitate GNSS and navigation-related processes and instructions; and/or camera instructions 1170 to facilitate camera-related processes and functions.

The memory 1150 can store software instructions 1172 to facilitate other processes and functions, such as the venue routing processes and functions as described with reference to FIGS. 1-10.

The memory 1150 can also store other software instructions 1174, such as web video instructions to facilitate web video-related processes and functions; and/or web shopping instructions to facilitate web shopping-related processes and functions. In some implementations, the media processing instructions 1166 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1150 can include additional instructions or fewer instructions. Furthermore, various functions of the computing device 1100 can be implemented in hardware and/or in software, including in one or more signal processing and/or application specific integrated circuits.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. A method comprising:
receiving, by a computing device, venue map data that defines relationships between origin map features and destination map features associated with a venue, the relationships including one or more constraints on travel between the origin map features and the destination map features;
receiving, by the computing device, a routing request for navigating within the venue, the routing request including a starting location and an ending location;
generating, by the computing device, a route through the venue from the starting location to the ending location based on relationships defined by the venue map data, including at least one relationship constraint; and
causing, by the computing device, the route to be presented on a display of a user device.

2. The method of claim 1, wherein the venue map data defines a particular relationship between a particular origin map feature and a particular destination map feature, and further comprising:
determining that the particular relationship defines a directional constraint; and
generating a route through the particular origin map feature and a particular destination map feature that complies with the directional constraint defined for the particular relationship.

3. The method of claim 1, wherein the venue map data defines a particular relationship between a particular origin map feature and a particular destination map feature, and further comprising:
determining that the particular relationship defines a temporal constraint; and
generating a route through the particular origin map feature and a particular destination map feature that complies with the temporal constraint defined for the particular relationship.

4. The method of claim 1, wherein the venue map data defines a particular relationship between a particular origin map feature and a particular destination map feature, and further comprising:
determining that the particular relationship defines a security constraint; and
generating a route through the particular origin map feature and the particular destination map feature that complies with the security constraint defined for the particular relationship.

5. The method of claim 1, wherein the venue map data defines a particular relationship between a particular origin map feature and a particular destination map feature, and further comprising:
determining that the particular relationship defines one or more intermediary features for moving from a first level of a venue to a second level of the venue; and
generating a route through the particular origin map feature to the particular destination map feature through the one or more intermediary map features.

6. The method of claim 5, wherein the one or more intermediary map features include at least an elevator, an escalator, a staircase, or a ramp.

7. The method of claim 1, wherein a particular origin map feature and a particular destination map feature are associated with a plurality of relationships defined in the venue map data.

8. A non-transitory computer readable medium including one or more sequences of instructions that, when executed by one or more processors, cause the processors to perform operations comprising:
receiving, by a computing device, venue map data that defines relationships between origin map features and destination map features associated with a venue, the relationships including one or more constraints on travel between the origin map features and the destination map features;
receiving, by the computing device, a routing request for navigating within the venue, the routing request including a starting location and an ending location;
generating, by the computing device, a route through the venue from the starting location to the ending location based on relationships defined by the venue map data, including at least one relationship constraint; and
causing, by the computing device, the route to be presented on a display of a user device.

9. The non-transitory computer readable medium of claim 8, wherein the venue map data defines a particular relationship between a particular origin map feature and a particular destination map feature, and wherein the instructions cause:
determining that the particular relationship defines a directional constraint; and
generating a route through the particular origin map feature and a particular destination map feature that complies with the directional constraint defined for the particular relationship.

10. The non-transitory computer readable medium of claim 8, wherein the venue map data defines a particular relationship between a particular origin map feature and a particular destination map feature, and wherein the instructions cause:
determining that the particular relationship defines a temporal constraint; and
generating a route through the particular origin map feature and a particular destination map feature that complies with the temporal constraint defined for the particular relationship.

11. The non-transitory computer readable medium of claim 8, wherein the venue map data defines a particular relationship between a particular origin map feature and a particular destination map feature, and wherein the instructions cause:
determining that the particular relationship defines a security constraint; and
generating a route through the particular origin map feature and the particular destination map feature that complies with the security constraint defined for the particular relationship.

12. The non-transitory computer readable medium of claim 8, wherein the venue map data defines a particular relationship between a particular origin map feature and a particular destination map feature, and wherein the instructions cause:
determining that the particular relationship defines one or more intermediary features for moving from a first level of a venue to a second level of the venue; and
generating a route through the particular origin map feature to the particular destination map feature through the one or more intermediary map features.

13. The non-transitory computer readable medium of claim 12, wherein the one or more intermediary map features include at least an elevator, an escalator, a staircase, or a ramp.

14. The non-transitory computer readable medium of claim 8, wherein a particular origin map feature and a particular destination map feature are associated with a plurality of relationships defined in the venue map data.

15. A system comprising:
one or more processors; and
a non-transitory computer readable medium including one or more sequences of instructions that, when executed by the one or more processors, cause the processors to perform operations comprising:
receiving, by a computing device, venue map data that defines relationships between origin map features and destination map features associated with a venue, the relationships including one or more constraints on travel between the origin map features and the destination map features;
receiving, by the computing device, a routing request for navigating within the venue, the routing request including a starting location and an ending location;
generating, by the computing device, a route through the venue from the starting location to the ending location based on relationships defined by the venue map data, including at least one relationship constraint; and
causing, by the computing device, the route to be presented on a display of a user device.

16. The system of claim 15, wherein the venue map data defines a particular relationship between a particular origin map feature and a particular destination map feature, and wherein the instructions cause:
determining that the particular relationship defines a directional constraint; and
generating a route through the particular origin map feature and a particular destination map feature that complies with the directional constraint defined for the particular relationship.

17. The system of claim 15, wherein the venue map data defines a particular relationship between a particular origin map feature and a particular destination map feature, and wherein the instructions cause:
determining that the particular relationship defines a temporal constraint; and
generating a route through the particular origin map feature and a particular destination map feature that complies with the temporal constraint defined for the particular relationship.

18. The system of claim 15, wherein the venue map data defines a particular relationship between a particular origin map feature and a particular destination map feature, and wherein the instructions cause:
determining that the particular relationship defines a security constraint; and
generating a route through the particular origin map feature and the particular destination map feature that complies with the security constraint defined for the particular relationship.

19. The system of claim 15, wherein the venue map data defines a particular relationship between a particular origin map feature and a particular destination map feature, and wherein the instructions cause:
determining that the particular relationship defines one or more intermediary features for moving from a first level of a venue to a second level of the venue; and
generating a route through the particular origin map feature to the particular destination map feature through the one or more intermediary map features.

20. The system of claim 19, wherein the one or more intermediary map features include at least an elevator, an escalator, a staircase, or a ramp.

21. The system of claim 15, wherein a particular origin map feature and a particular destination map feature are associated with a plurality of relationships defined in the venue map data.
